(19) United States
(12) Patent Application Publication
(10) Pub. No.: US 2025/0060899 A1
(43) Pub. Date: Feb. 20, 2025

(54) MIRRORED MEMORY REGIONS ACROSS MULTIPLE SUB-CHANNELS

(71) Applicant: Microsoft Technology Licensing, LLC, Redmond, WA (US)

(72) Inventor: Xiang MA, Portland, OR (US)

(21) Appl. No.: 18/451,712

(22) Filed: Aug. 17, 2023

(51) Int. Cl. G06F 3/06

(52) U.S. Cl. CPC G06F 3/065; G06F 3/0658; G06F 3/0604; G06F 3/0671

(57) ABSTRACT

Embodiments of the present disclosure include techniques for memory management. In various embodiments. a memory controller mirrors memory transactions on first data in a memory when the address for the transaction is within a first range. Transactions outside the first range may not be mirrored.

### BACKGROUND

The present disclosure relates generally to memory management, and in particular, to mirrored memory regions across multiple sub-channels.

Digital memory stores digital data as zeros (0) and one (1). Memory architectures have advanced significantly over the years to store more data as well as manage the data stored. Advancements in memory management techniques include pushing technological boundaries to deliver more storage, better throughput, and lower power. As memory architectures advance the size and speed of memory systems, it becomes more challenging to provide highly reliable system memory due to manufacturing process and limitations. Additionally, security in modem memory systems is an increasingly important issue stemming from the rising number of cybersecurity attacks directed at memories.

The present disclosure is directed to memory management techniques the offer security and/or reliability advantages.

### BRIEF DESCRIPTION OF THE DRAWINGS

FIG. 1 illustrates a system for mirroring memory regions across multiple sub-channels according to an embodiment.

FIG. 2 illustrates a memory management method according to an embodiment.

FIG. 3 illustrates an example memory read according to an embodiment.

FIG. 4 illustrates an example memory read according to another embodiment.

FIG. 5 illustrates an example memory read according to yet another embodiment.

FIG. 6 illustrates an example memory management technique according to yet another embodiment.

### DETAILED DESCRIPTION

Described herein are techniques for memory management. In the following description, for purposes of explanation, numerous examples and specific details are set forth in order to provide a thorough understanding of some embodiments. Various embodiments as defined by the claims may include some or all of the features in these examples alone or in combination with other features described below and may further include modifications and equivalents of the features and concepts described herein.

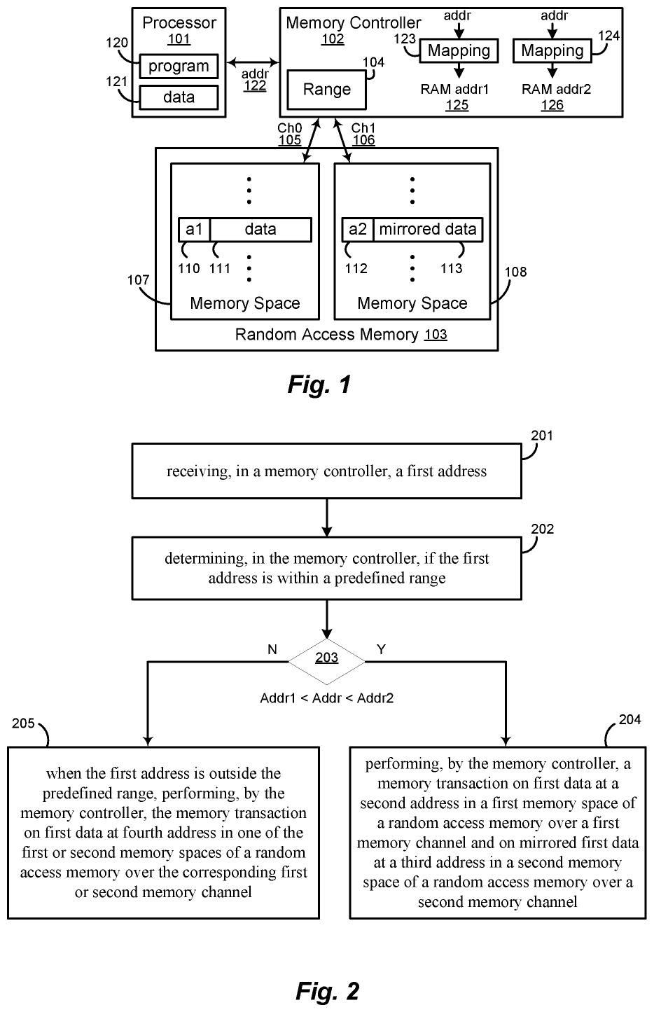

FIG. 1 illustrates a system for mirroring memory regions across multiple sub-channels according to an embodiment. Embodiments of the present disclosure may automatically mirror data transactions across multiple channels of a memory (e.g., random access memory, RAM), which may be used for a variety of advantages during memory operation. As illustrated in FIG. 1, a memory controller 102 receives an address 122 for a memory transaction (e.g., a read or write). Memory controller 102 determines if address 122 is within a predefined range 104. The predefined range 104 may be used to determine data transactions that are mirrored across multiple different memory spaces 107 and 108 in a RAM 103, for example. Predefined range 104 may be programmed into the memory controller, for example. If address 122 is in predefined range 104 (e.g., range address low <address 122<range address high), memory controller 102 performs a memory transaction (e.g., read or write) on data 111 at address 110 in memory space 107 over a first memory channel (Ch0) 105. Additionally, if address 122 is in predefined range 104, memory controller 102 performs the memory transaction on mirrored data 113 at address 112 in a second memory space 108 over a second memory channel (Ch1) 106. In some embodiments, address 112 may be a system physical address (e.g., an address to memory 103 from a processor's perspective). Additionally, in some embodiments addresses 110 and 112 may be a random access memory physical addresses. For example, in one embodiment RAM 103 is a dual inline memory module (DIMM), and addresses 110 and 112 are DIMM physical addresses specifying a rank, bank, row, and column in the memory, which may be encoded in address, for example.

More widely, in some embodiments, a system according to the present disclosure further comprises a processor 101 executing one or more programs (e.g., applications) 120. Program 120 may determine that different data 121 (e.g., application data) is to be stored according to different security levels, for example. Data deemed very sensitive or critical may be mirrored in RAM 103, while data not deemed as critical may not be mirrored in RAM 103. Accordingly, program 120 executing on processor 101 may determine data elements (e.g., portions or bytes of data) to be stored at addresses in the predefined range. Processor 101 may store critical data more securely, using mirroring, by associating the data with an address in the predefined range 104. Data written to system physical addresses in predefined range 104 are mirrored, while data written to system physical addresses outside the predefined range are not mirrored. For example, memory transactions within the predefined range 104 are mirrored on the first and second memory channels 105 and 106, and memory transactions outside the predefined range 104 are not mirrored on the first and second memory channels.

The following illustrates a write transaction according to an embodiment. Program 120 may determine that particular data requires a first level of security greater than other data stored according to least one other level of security or no memory security implemented by the memory controller, for example. Program 120 may generate a write command associated with the data 121 to be stored as well as a first system physical address (e.g., addr 122) within the predefined range 104. Memory controller 102 may translate the first system physical address into a physical memory address 125 and a physical memory address 126. Next, memory controller 102 writes the data to the first physical memory address 125 in RAM 103 over the first channel Ch0 105. Additionally, memory controller 102 writes the mirrored data to the second physical memory address 126 in RAM 103 over the second channel Ch1 106.

The following illustrates a write transaction according to an embodiment. Program 120 may determine that the data is stored in RAM using a first level of security greater than other data stored according to least one other level of security or no memory security. For critical data, program 120 generates a read command associated with the first system physical address within the predefined range 104. Memory controller 102 translates the first system physical address 122 into the first physical memory address 125 and second physical memory address 126. Memory controller 102 reads the data at the first physical memory address 125 in RAM 103 over the first channel 105, and the memory controller 102 reads the mirrored data at the second physical memory address 126 in RAM 103 over the second channel.

Mirrored data transactions may be performed in a variety of advantageous ways to improve memory usage. For example, in some embodiments, data is stored in one memory space 107 and mirrored data is stored in the same corresponding address in second memory space 108. Accordingly, the physical memory address in the first memory space 107 may be the same corresponding address as the physical memory address in the second memory space 108. However, in other embodiments described in more detail below, address 110 for data 111 stored in the first memory space 107 may be different than address 112 for data 113 in memory space 108 (e.g., different non-corresponding rows in different parts of a DIMM). For instance, as illustrated in examples below, memory controller 102 may use a first address mapping 123 between address 122 and a physical memory address 125 and a different second address mapping 124 between address 122 and a physical memory address 126 so that the physical memory address 125 in the first memory space 107 is a different (non-corresponding) address than physical memory address 126 in the second memory space 108. Features and advantages of these embodiments are illustrated further below.

FIG. 2 illustrates a memory management method according to an embodiment. At 201, a first address is received in a memory controller. At 202, the memory controller determines if the first address is within a predefined range. The address may be compared to a first lower range address value (e.g., Add1) and a second upper range address value (e.g., Addr2), for example. At 204, when the first address is within the predefined range, the memory controller performs a memory transaction on first data at a second address in a first memory space of a random access memory over a first memory channel and on mirrored first data at a third address in a second memory space of the random access memory over a second memory channel. However, at 205, when the first address is outside the predefined range, the memory controller performs the memory transaction on first data at fourth address in one of the first or second memory spaces of the random access memory over the corresponding first or second memory channel.

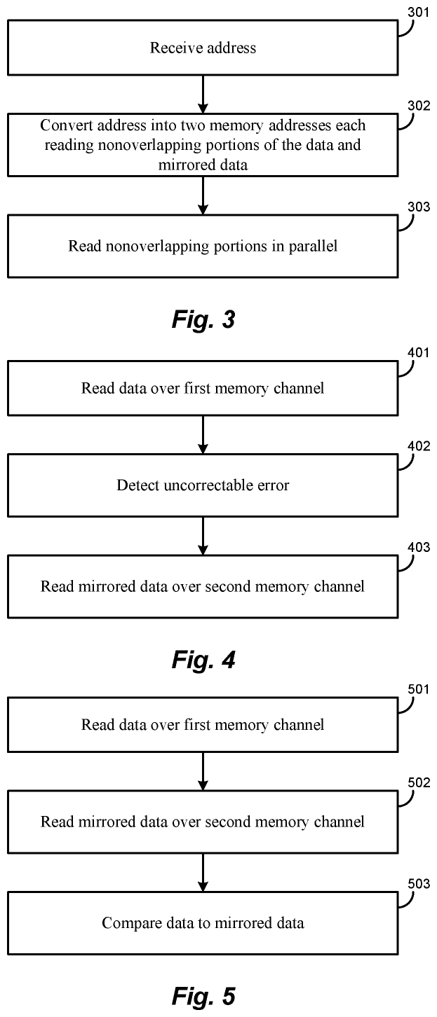

FIG. 3 illustrates an example memory read according to an embodiment. In this example, the mirroring techniques described herein may be used for increasing the speed of a read operation. If data is mirrored in two different places in a RAM, then a read transaction may be divided (e.g., in half) and performed in parallel, where each channel reads a nonoverlapping portion of the data. Because each channel is reading less data, the speed of the read operation is improved. As illustrated in FIG. 3, a memory controller receives an address at 301. The address may be in the predefined range mentioned above. At 302, the memory controller converts the address into two RAM addresses each directed at reading nonoverlapping portions of the data/mirrored data. At 303, the nonoverlapping portions of data (e.g., each half) is read across two channels in parallel. Accordingly, a memory controller may read a first portion of the data over the first memory channel and a second portion of the data in the mirrored first data over the second memory channel. For example, if the data is 64 bytes, then each channel may read 32 bytes. A first memory channel may be used to read the first 32 bytes from a start RAM address for the data to an intermediate RAM address, and the second memory channel may be used to read the second 32 bytes from the intermediate RAM address to an end RAM address for the data. This may occur in parallel, for example, resulting in a faster read operation.

FIG. 4 illustrates an example memory read according to another embodiment. In some embodiments, data mirroring may be used to detect errors and make the system more resilient. In some cases, data read from memory may result in an uncorrectable error. However, data mirroring allows the system to overcome such uncorrectable errors. For instance, at 401, at least a first portion of the data is read over a first memory channel. At 402, the memory controller detects that the data returned by the first channel has an uncorrectable error. At 403, the portion of the data read over the first memory channel is read over the second memory channel to obtain a valid copy of the data (in the mirrored data) with the uncorrectable error.

FIG. 5 illustrates an example memory read according to yet another embodiment. In some cases, data may be read from a memory, pass CRC (cycle redundancy checks), and be output as good data, when in fact it is erroneous data. For critical data, mirroring may be used to verify that the data read is, in fact, good data. As illustrated in FIG. 5, a memory controller reads the first data over the first memory channel at 501 and reads the mirrored first data over the second memory channel at 502. At 503, the memory controller may compare the data read over the first memory channel to the mirrored data read over the second memory channel. When the data matches the mirrored data, the data is verified as good data, for example. However, in some cases the data may not match. In some embodiments, a historical record (aka, log) of sources (e.g., channel, row, etc. . . . ) of mismatched data may be stored and tracked to determine, historically, which sources of data are more likely the source of invalid data. In some cases, logs may be used to determine a likelihood of which of the two mismatching data values are incorrect.

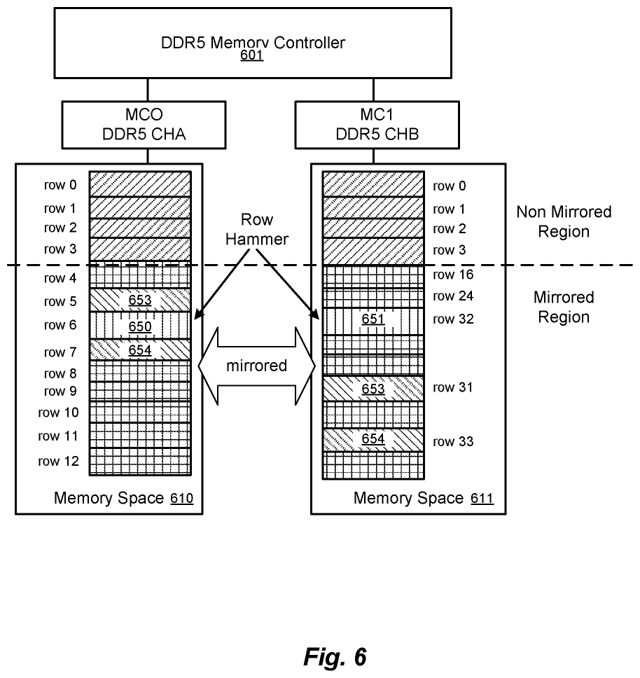

FIG. 6 illustrates an example memory management technique according to yet another embodiment. One particular type of security attack is referred to as the row hammer attack. In a row hammer attack, a particular row of memory is activated repeatedly, thereby potentially causing errors in adjacent memory rows. As mentioned above, features and advantages of the present disclosure may include a memory controller that uses a first address mapping between the system address from the CPU and a first RAM address over one memory channel and a second address mapping between the system address and a second RAM address over another memory channel so that the first RAM address in the first memory space is a different address than the second RAM address in the second memory space. Additionally, the mappings may be configured so that data at the first RAM address is adjacent to different data than the mirrored data at the second RAM address in the random access memory. For example, data 650 may be mapped to row 6 of memory space 610 having adjacent data in rows 5 and 7. However, mirrored data 651 corresponding to data 650 may be mapped to row 32 of memory space 611, which has different data in adjacent rows, for example. In this example, the data adjacent to data 650 in memory space 610 is in rows 31 and 33. Accordingly, a row hammer attack on row 6 in memory space 610 resulting in the loss of data in the adjacent rows 653/654 may be overcome by reading the data from rows 31 and 33 in memory space 611.

### FURTHER EXAMPLES

Each of the following non-limiting features in the following examples may stand on its own or may be combined in various permutations or combinations with one or more of the other features in the examples below. In various embodiments, the present disclosure may be implemented as a system or method.

In one embodiment, the present disclosure includes a system comprising: a memory controller to receive a first address and determining if the first address is within a predefined range; and a random access memory to stored data, wherein when the first address is within the predefined range, performing, by the memory controller, a memory transaction on first data at a second address in a first memory space over a first memory channel and on mirrored first data at a third address in a second memory space over a second memory channel.

In another embodiment, the present disclosure includes a memory management method comprising: receiving, in a memory controller, a first address; determining, in the memory controller, if the first address is within a predefined range; and when the first address is within the predefined range, performing, by the memory controller, a memory transaction on first data at a second address in a first memory space of a random access memory over a first memory channel and on mirrored first data at a third address in a second memory space of the random access memory over a second memory channel, and when the first address is outside the predefined range, performing, by the memory controller, the memory transaction on first data at fourth address in one of the first or second memory spaces of the random access memory over the corresponding first or second memory channel.

In one embodiment, the first address is a system physical address and wherein the second and third addresses are random access memory physical addresses.

In one embodiment, second address in the first memory space is the same corresponding address as the third address in the second memory space.

In one embodiment, the memory controller uses a first address mapping between first address and the second address and a second address mapping between the first address and the third address so that the second address in the first memory space is a different address than the third address in the second memory space.

In one embodiment, the first data at the second address is adjacent to different data than the mirrored first data at the third address in the random access memory.

In one embodiment, memory transactions within the predefined range are mirrored on the first and second memory channels, and wherein memory transactions outside the predefined range are not mirrored on the first and second memory channels.

In one embodiment, the predefined range is programmed into the memory controller.

In one embodiment, the system further comprising a processor executing a program, wherein the program determines a plurality of data elements, including the first data, to be stored at addresses in the predefined range, and the program comprises other data elements, not including the first data, having addresses to be stored outside the predefined range in the random access memory.

In one embodiment, the memory transaction is a write transaction and wherein the first address is a first system physical address, and wherein the program: determines that the first data requires a first level of security greater than other data stored according to least one other level of security or no memory security; generates a write command associated with the first data and the first system physical address within the predefined range; and the memory controller translates the first system physical address into the second address and third address, wherein the second address is a first physical memory address and the third address is a second physical memory address; the memory controller writes the first data to the first physical memory address in the random access memory over the first channel, and the memory controller writes the mirrored first data to the second physical memory address in the random access memory over the second channel.

In one embodiment, the memory transaction is a read transaction and wherein the first address is a first system physical address, and wherein the program: determines that the first data is stored using a first level of security greater than other data stored according to least one other level of security or no memory security; generates a read command associated with the first system physical address within the predefined range; and the memory controller translates the first system physical address into the first physical memory address and second physical memory address; the memory controller reads the first data at the first physical memory address in the random access memory over the first channel, and the memory controller reads the mirrored first data at the second physical memory address in the random access memory over the second channel.

In one embodiment, the memory transaction is a read transaction, and wherein the memory controller reads a first portion of the first data over the first memory channel and a second portion of the first data in the mirrored first data over the second memory channel in parallel.

In one embodiment, the memory transaction is a read transaction, and wherein the memory controller: reads at least a first portion of the first data over the first memory channel, detects an uncorrectable error in at least the first portion of the first data, and reads at least the first portion of the first data in the mirrored first data over the second memory channel.

In one embodiment, the memory transaction is a read transaction, and wherein the memory controller: reads the first data over the first memory channel, reads the mirrored first data over the second memory channel, and compares the first data read over the first memory channel to the mirrored first data read over the second memory channel.

In one embodiment, the memory controller generates an error flag when the first data read over the first memory channel does not match the first data read over the second memory channel.

In one embodiment, the random access memory is a synchronous double data rate 5 (DDR5) dual inline memory module.

The above description illustrates various embodiments along with examples of how aspects of some embodiments may be implemented. The above examples and embodiments should not be deemed to be the only embodiments, and are presented to illustrate the flexibility and advantages of some embodiments as defined by the following claims. Based on the above disclosure and the following claims, other arrangements, embodiments, implementations and equivalents may be employed without departing from the scope hereof as defined by the claims.

What is claimed is:

1. A system comprising:
a memory controller to receive a first address and determining if the first address is within a predefined range; and
a random access memory to stored data,
wherein when the first address is within the predefined range, performing, by the memory controller, a memory transaction on first data at a second address in a first memory space over a first memory channel and on mirrored first data at a third address in a second memory space over a second memory channel.

2. The system of claim 1, wherein the first address is a system physical address and wherein the second and third addresses are random access memory physical addresses.

3. The system of claim 1, wherein second address in the first memory space is the same corresponding address as the third address in the second memory space.

4. The system of claim 1, wherein the memory controller uses a first address mapping between first address and the second address and a second address mapping between the first address and the third address so that the second address in the first memory space is a different address than the third address in the second memory space.

5. The system of claim 4, wherein the first data at the second address is adjacent to different data than the mirrored first data at the third address in the random access memory.

6. The system of claim 1, wherein memory transactions within the predefined range are mirrored on the first and second memory channels, and wherein memory transactions outside the predefined range are not mirrored on the first and second memory channels.

7. The system of claim 1, wherein the predefined range is programmed into the memory controller.

8. The system of claim 1, further comprising a processor executing a program, wherein the program determines a plurality of data elements, including the first data, to be stored at addresses in the predefined range, and the program comprises other data elements, not including the first data, having addresses to be stored outside the predefined range in the random access memory.

9. The system of claim 8, wherein the memory transaction is a write transaction and wherein the first address is a first system physical address, and wherein the program:
determines that the first data requires a first level of security greater than other data stored according to least one other level of security or no memory security;
generates a write command associated with the first data and the first system physical address within the predefined range; and
the memory controller translates the first system physical address into the second address and third address, wherein the second address is a first physical memory address and the third address is a second physical memory address;
the memory controller writes the first data to the first physical memory address in the random access memory over the first channel, and the memory controller writes the mirrored first data to the second physical memory address in the random access memory over the second channel.

10. The system of claim 8, wherein the memory transaction is a read transaction and wherein the first address is a first system physical address, and wherein the program:
determines that the first data is stored using a first level of security greater than other data stored according to least one other level of security or no memory security;
generates a read command associated with the first system physical address within the predefined range; and
the memory controller translates the first system physical address into the first physical memory address and second physical memory address;
the memory controller reads the first data at the first physical memory address in the random access memory over the first channel, and the memory controller reads the mirrored first data at the second physical memory address in the random access memory over the second channel.

11. The system of claim 1, wherein the memory transaction is a read transaction, and wherein the memory controller reads a first portion of the first data over the first memory channel and a second portion of the first data in the mirrored first data over the second memory channel in parallel.

12. The system of claim 1, wherein the memory transaction is a read transaction, and wherein the memory controller:
reads at least a first portion of the first data over the first memory channel,
detects an uncorrectable error in at least the first portion of the first data, and
reads at least the first portion of the first data in the mirrored first data over the second memory channel.

13. The system of claim 1, wherein the memory transaction is a read transaction, and wherein the memory controller:
reads the first data over the first memory channel,
reads the mirrored first data over the second memory channel, and
compares the first data read over the first memory channel to the mirrored first data read over the second memory channel.

14. The system of claim 13, wherein the memory controller generates an error flag when the first data read over the first memory channel does not match the first data read over the second memory channel.

15. The system of claim 1, wherein the random access memory is a synchronous double data rate 5 (DDR5) dual inline memory module.

16. A memory management method comprising:
receiving, in a memory controller, a first address;
determining, in the memory controller, if the first address is within a predefined range; and
when the first address is within the predefined range, performing, by the memory controller, a memory transaction on first data at a second address in a first memory space of a random access memory over a first memory channel and on mirrored first data at a third address in a second memory space of the random access memory over a second memory channel, and
when the first address is outside the predefined range, performing, by the memory controller, the memory transaction on first data at fourth address in one of the first or second memory spaces of the random access memory over the corresponding first or second memory channel.

17. The method of claim 16, wherein the memory controller uses a first address mapping between first address and the second address and a second address mapping between the first address and the third address so that the second address in the first memory space is a different address than the third address in the second memory space so that the first data at the second address is adjacent to different data than the mirrored first data at the third address in the random access memory.

18. The method of claim 16, wherein the memory transaction is a read transaction, and wherein the memory controller reads a first portion of the first data over the first memory channel and a second portion of the first data in the mirrored first data over the second memory channel in parallel.

19. The method of claim 16, wherein the memory transaction is a read transaction, and wherein the memory controller:
reads at least a first portion of the first data over the first memory channel,
detects an uncorrectable error in at least the first portion of the first data, and
reads at least the first portion of the first data in the mirrored first data over the second memory channel.

20. The method of claim 16, wherein the memory transaction is a read transaction, and wherein the memory controller:
reads the first data over the first memory channel,
reads the mirrored first data over the second memory channel, and
compares the first data read over the first memory channel to the mirrored first data read over the second memory channel.
